(19) United States
(12) Patent Application Publication
(10) Pub. No.: US 2020/0296225 A1
(43) Pub. Date: Sep. 17, 2020

(54) IMAGE FORMING APPARATUS THAT USES SPECTRAL SENSOR

(71) Applicant: CANON KABUSHIKI KAISHA, Tokyo (JP)

(72) Inventor: Toshihisa Yago, Toride-shi (JP)

(21) Appl. No.: 16/806,713

(22) Filed: Mar. 2, 2020

(30) Foreign Application Priority Data
Mar. 15, 2019 (JP) 2019-048744

(51) Int. Cl. H04N 1/00; H04N 1/60

(52) U.S. Cl. CPC H04N 1/00034; H04N 1/00087; H04N 1/6025; H04N 1/00779; H04N 1/6094; H04N 1/00724

(57) ABSTRACT

An image forming apparatus determines a correction value for correcting an output value of each of first spectral sensors, based on a measurement result of a first measurement image acquired by the first spectral sensors and a measurement result of the first measurement image acquired by a second spectral sensor while the second spectral sensor is being moved, corrects, using the determined correction value, an output value output from each of the plurality of first spectral sensors by measuring a second measurement image, and modifies an image forming condition based on the corrected output value.

### BACKGROUND OF THE INVENTION

### Field of the Invention

The present invention relates to an image forming apparatus that uses a spectral sensor.

### Description of the Related Art

There is a demand from the market to bring the print quality of an electrophotographic image forming apparatus closer to the print quality of an offset printing machine. In order to achieve this, calibration for adjusting image forming conditions depending on environmental variations or the like is required.

Japanese Patent Laid-Open No. 2004-086013 describes detecting a toner patch using a single spectral sensor and correcting an image forming condition based on the detection result. However, with only one sensor, the time taken for reading the toner patch becomes long. Accordingly, Japanese Patent Laid-Open No. 2016-122072 describes shortening the time taken to read the toner patch by arranging a plurality of spectral sensors and a plurality of toner patches along the main scanning direction.

In Japanese Patent Laid-Open No. 2016-122072, since a plurality of spectral sensors arranged in the main scanning direction are used, a technique for correcting individual differences among the plurality of spectral sensors is required. In Japanese Patent Laid-Open No. 2016-122072, it is proposed that a white background portion of a sheet is read by each spectral sensor, and individual differences are corrected based on the read results. However, even if the sheet appears uniformly as a white background to the human eye, there actually exists nonuniformity in spectral reflectance in the main scanning direction. Therefore, the Japanese Patent Laid-Open No. 2016-122072 approach may not be able to reduce the effects of sheet nonuniformities.

### SUMMARY OF THE INVENTION

One of embodiments of the present invention provides an image forming apparatus comprising the following elements. A conveyance unit conveys a sheet in a first direction. An image forming unit forms an image on the sheet. A plurality of first spectral sensors measure a first measurement image formed by the image forming unit on the sheet along a second direction intersecting the first direction. A second spectral sensor measures the first measurement image formed on the sheet. A movement unit moves the second spectral sensor along a third direction intersecting the first direction. A controller determines a correction value for correcting an output value of each of the plurality of first spectral sensors, based on a measurement result of the first measurement image acquired by the plurality of first spectral sensors and a measurement result of the first measurement image acquired by the second spectral sensor while the second spectral sensor is being moved in the third direction by the movement unit, corrects, using the determined correction value, the output value output from each of the plurality of first spectral sensors by measuring a second measurement image that is formed by the image forming unit and that is for modifying an image forming condition of the image forming unit, and modifies the image forming condition based on the output value corrected by the correction unit.

Further features of the present invention will become apparent from the following description of exemplary embodiments (with reference to the attached drawings).

### BRIEF DESCRIPTION OF THE DRAWINGS

FIG. 1 is a schematic configuration diagram of an image forming apparatus.

FIG. 2 is a schematic configuration diagram of a spectral sensor.

FIG. 3 is a diagram illustrating a calculation unit.

FIG. 4 is a diagram illustrating a control system.

FIG. 5 is a view for showing another example of the calculation unit.

FIG. 6 is a view for describing an arrangement of measurement images and spectral sensors.

FIG. 7 is a view for describing an arrangement of measurement images and spectral sensors.

FIG. 8 is a flowchart for describing calibration.

FIG. 9 is a flowchart for describing a process for determining a correction value.

FIGS. 10A and 10B are diagrams for describing correction of chromaticity.

FIG. 11 is a diagram illustrating a correction table.

FIG. 12 is a diagram for describing individual differences between spectral sensors.

FIG. 13 is a view for showing another example of the calculation unit.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

### Image Forming Apparatus

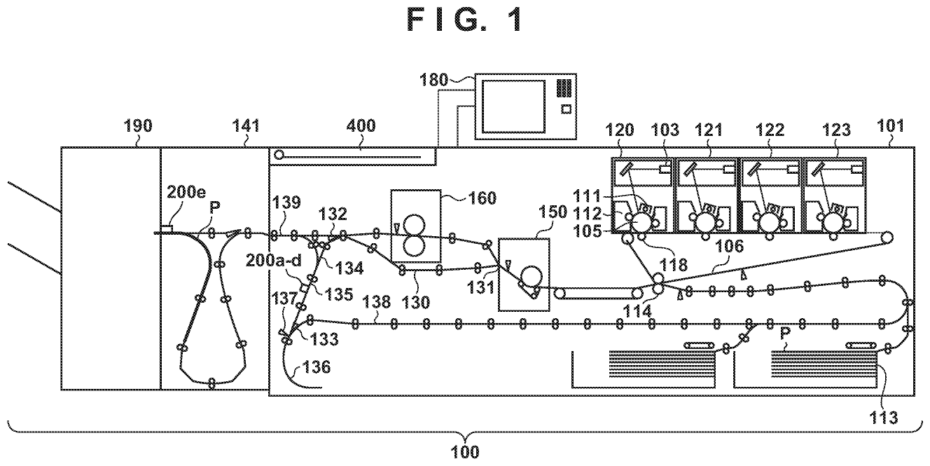

As illustrated in FIG. 1, an image forming apparatus 100 includes a printer 101, a reader 400, an operation unit 180, a buffer 141, and a finisher 190. The printer 101 has four stations 120, 121, 122 and 123. Station 120 forms a yellow image. Station 121 forms a magenta image. Station 122 forms a cyan image. Station 123 forms a black image. In the following, YMCK represents yellow, magenta, cyan and black, respectively. Since each station has the same configuration, the configuration of the station 120 for forming a yellow image will be mainly described below. A photosensitive drum 105 is a photosensitive member having a photosensitive layer on its surface. A charger 111 charges the photosensitive drum 105 so that the potential of the surface of the photosensitive drum 105 becomes a predetermined potential. An exposure apparatus 103 irradiates the photosensitive drum 105 with a laser beam based on image data to form an electrostatic latent image. A developing device 112 develops the electrostatic latent image using toner to form a toner image. The developing device 112 applies a development bias to the developing sleeve to cause toner to adhere to the electrostatic latent image.

A primary transfer roller 118 transfers the toner image carried on the photosensitive drum 105 to an intermediate transfer belt 106. A transfer potential for promoting transfer of the toner image is also applied to the primary transfer roller 118. The intermediate transfer belt 106 conveys toner images formed by the stations 120, 121, 122, and 123 to a secondary transfer position. A secondary transfer roller 114 is provided at the secondary transfer position. The secondary transfer roller 114 transfers the toner image carried on the intermediate transfer belt 106 to a sheet P conveyed from a container 113. A transfer potential for promoting transfer of the toner image is also applied to the secondary transfer roller 114. The sheet P on which the toner image has been transferred is conveyed to the fixing device 150.

The fixing device 150 applies heat and pressure to the sheet P and the toner image to fix the toner image to the sheet P. A flapper 131 guides the sheet P to a fixing device 160 or a conveyance path 130. The fixing device 160 is provided to increase the gloss (sheen) of the toner image formed on the sheet P or improve the fixing property of cardboard or the like.

A flapper 132 is a guiding member for guiding the sheet P to a conveyance path 135 or a conveyance path 139. The conveyance path 139 conveys the sheet P to the buffer 141. The conveyance path 135 conveys the sheet P to an inversion portion 136. When an inversion sensor 137 provided in the conveyance path 135 detects the rear end of the sheet P, the conveyance direction of the sheet P is reversed. A flapper 133 is a guiding member for switching guidance of the sheet P to a conveyance path 138 or guidance to a conveyance path 135. When a face down discharge mode is instructed by the user, the flapper 133 conveys the sheet P to the conveyance path 135 again. Further, the flapper 134 guides the sheet P to the conveyance path 139. As a result, the sheet P is discharged from the image forming apparatus 100 with the printing surface of the sheet P facing downward. When a double-sided print mode is instructed by the user, the flapper 133 guides the sheet P to the conveyance path 138. The conveyance path 138 conveys the sheet P on a first surface of which the image is formed to the secondary transfer position again. As a result, an image is also formed on a second surface of the sheet P.

Spectral sensors 200a to 200d for measuring the measurement image formed on the sheet P are arranged in the conveyance path 135. Note that the alphabet characters added to the end of the reference numerals will be omitted when common matters are described. As measurement images, there are at least a measurement image used in calibration for adjusting image forming conditions, and a measurement image for correcting individual differences between the spectral sensors 200a to 200d. A measurement image generally has a plurality of test patterns.

The operation unit 180 includes a display device (e.g.: a liquid crystal display) and an input device (e.g.: a touch panel or hardware keys). The operation unit 180 is a user interface for accepting designation of a number of print sheets for an image and a print mode from the user. The reader 400 reads an original placed on an original platen and generates image data.

The buffer 141 is a post-processing device that temporarily holds the sheet P to be conveyed to the finisher 190. The finisher 190 is a post-processing device that executes post-processing such as punching processing, stapling processing, and bookbinding processing. If the finisher 190 has not completed the post-processing of the preceding sheet P, the subsequent sheet P waits in the buffer 141. In the present embodiment, the spectral sensor 200e is provided on the conveyance path in the buffer 141. The spectral sensor 200e also measures an image for measurement in the same manner as the spectral sensors 200a to 200d. The measurement result of the spectral sensor 200e is used to correct individual differences between the spectral sensors 200a to 200d. The image forming apparatus 100 has various conveyance paths, and conveyance rollers or conveyance belts driven by motors are provided for each conveyance path.

Spectral Sensors

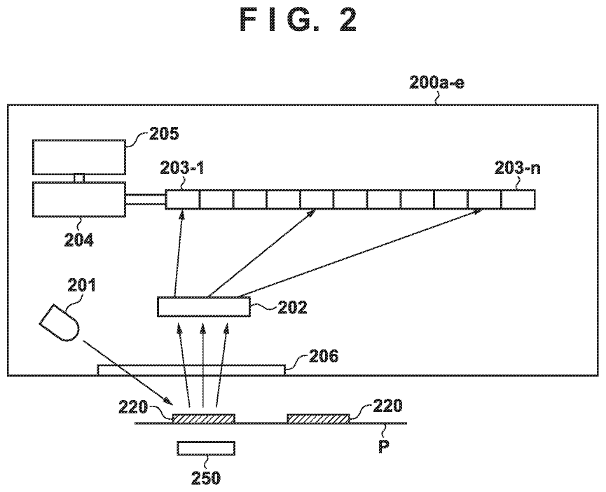

As illustrated in FIG. 2, the spectral sensor 200 includes a white LED 201, a diffraction grating 202, a line sensor 203, a calculation unit 204, and a memory 205. The white LED 201 illuminates the measurement image 220 formed on the sheet P with light. The diffraction grating 202 is a spectral element that separates the light reflected from the measurement image 220 into respective wavelengths. The line sensor 203 includes n light receiving elements (n pixels). The calculation unit 204 performs various calculations based on the light intensity detected by each pixel of the line sensor 203. The memory 205 stores various data.

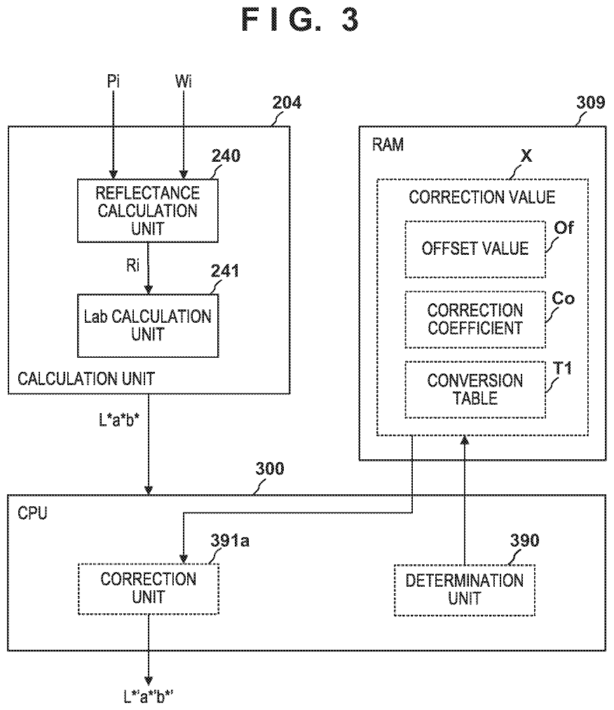

The spectral sensor 200 detects the light intensity of the reflected light at intervals of 10 [nm] from 380 [nm] to 720 [nm], for example. In this case, n=34. That is, 34 pixels are arranged such that the first pixel receives light having a wavelength of 380 [nm] to 390 [nm], and the 34th pixel receives light having a wavelength of 710 [nm] to 720 [nm]. As illustrated in FIG. 3, the calculation unit 204 may include a reflectance calculation unit 240 that calculates the spectral reflectance based on the light intensity detected by each pixel, a Lab calculation unit 241 that calculates an L*a*b* value, and the like. The spectral sensor 200 may include a lens 206 that focuses light emitted from the white LED 201 onto the measurement image 220 on the sheet P or focuses light reflected from the measurement image 220 onto the diffraction grating 202.

The spectral sensor 200 may include a white reference plate 250. The spectral sensor 200 uses the white reference plate 250 to adjust the amount of light of the white LED 201. The spectral sensor 200 causes the white LED 201 to emit light while the sheet P is not passing through the measurement position of the spectral sensor 200, and receives, by the line sensor 203, light reflected from the white reference plate 250. The calculation unit 204 adjusts the emission intensity of the white LED 201 so that the light intensity of a predetermined pixel in the line sensor 203 becomes a predetermined value. The reflectance calculation unit 240 illustrated in FIG. 3 may calculate the spectral reflectance Ri of the measurement image based on the following equation, for example.

Ri=Pi/Wi (1)

Here, Pi is a detection result of the line sensor 203 corresponding to the reflected light from the measurement image 220. Wi is a detection result of the line sensor 203 corresponding to the reflected light from the white reference plate 250. i is an index indicating a wavelength (i=1 to n). The spectral sensor 200 acquires the detection result Wi of the white reference plate 250 before the measurement image 220 arrives. The Lab calculation unit 241 calculates L*a*b* using the spectral reflectances R1 to Rn of the measurement image. Since a calculation method for obtaining L*a*b* from spectral reflectance is known, a detailed description thereof will be omitted.

In FIG. 3, a CPU 300 (a determination unit 390) may determine a correction value X for correcting the measurement result of the spectral sensors 200a to 200d based on the measurement result of the spectral sensors 200a to 200d and the measurement result of the spectral sensor 200e. The RAM 309 is a storage device for storing the correction value X. The correction value X may be any of an offset value Of, a correction coefficient Co, and a conversion table T1, which will be described later. A correction unit 391a corrects L*a*b* which is a measurement result of the spectral sensors 200a to 200d to L*′a*′b*′ using the correction value X. This reduces individual differences between the spectral sensors 200a to 200d.

Control System

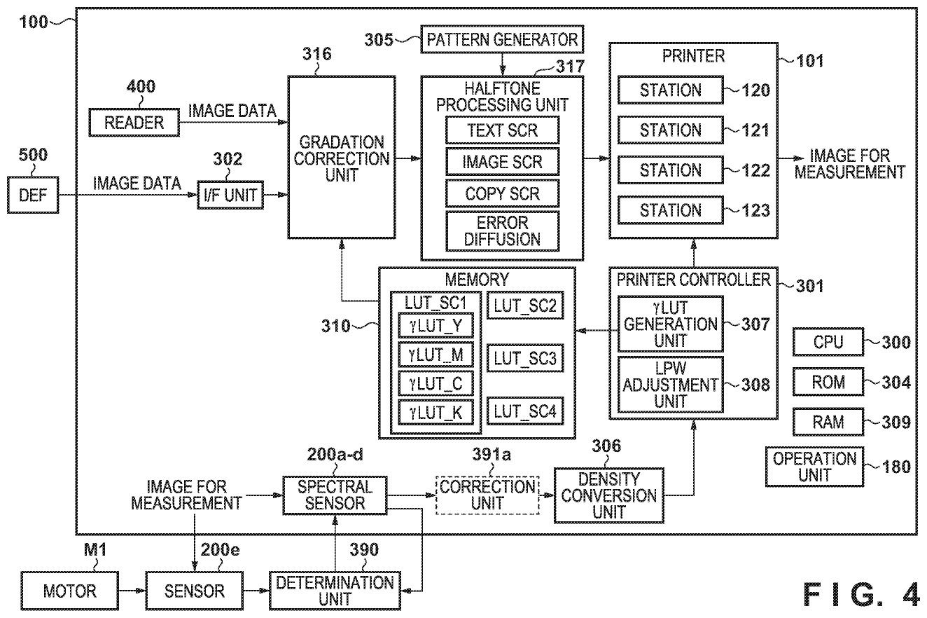

FIG. 4 illustrates a control system of the image forming apparatus 100. In this example, a digital front end (DFE) 500 is connected to the image forming apparatus 100. The DFE 500 is an image processing device that executes raster image processing, color conversion, and the like.

The CPU 300 is a control circuit for controlling each unit of the image forming apparatus 100. A ROM 304 is a storage device for storing control programs executed by the CPU 300 and required for executing various adjustments, processes, and the like. A RAM 309 is a system work memory for the CPU 300 to operate. An I/F unit 302 is an interface (communication circuit) connected to the DFE 500 and receives image data (e.g.: bitmap information with attributes) outputted from the DFE 500. The attributes are information indicating types of image objects included in the image data inputted to the DFE 500. Attributes include, for example, photographs, graphics (shapes), text (characters), etc. A gradation correction unit 316 performs gradation correction processing on the image data input from a reader 400 or the I/F unit 302. That is, the gradation correction unit 316 functions as a correction unit that converts image data based on gradation correction conditions. The printer 101 functions as an image forming unit that forms an image on a sheet based on the image data corrected by the correction unit. Note that the gradation correction unit 316 individually performs gradation correction on the respective Y, M, C, and K image data. COPY may be added as an attribute to the image data inputted from the reader 400 to indicate copying. The gradation correction unit 316 performs gradation correction by referring to an LUT associated with an attribute stored in the memory 310. LUT is an abbreviation of LookUp Table, and may be called a gradation correction condition or a gradation correction table. A halftone processing unit 317 also executes halftone processing (halftoning) according to an attribute. The reason why the halftone processing is changed according to the object is as follows. Characters printed on a sheet P have curves as well as straight lines. Therefore, unless the number of lines of the screen large, the outline of the character will not be reproduced smoothly. On the other hand, if halftoning is performed in relation to a photograph using a screen with many lines, there is a possibility that an image with a uniform density will not be reproducible. Therefore, the gradation correction unit 316 executes halftone processing suitable for the object, and converts the image data based on an LUT corresponding to the halftone processing.

The reason why the gradation correction is necessary is as follows. If the state of developer in the developing device 112 or the temperature or humidity inside the image forming apparatus 100 changes, a density characteristic (gradation characteristic) of the image formed by the image forming apparatus 100 will vary. The gradation correction unit 316 converts an input value (image signal value) of image data into a signal value for the printer 101 to form an image of a target density so that the density characteristic (gradation characteristic) of the image formed by the printer 101 becomes an ideal density characteristic.

The gradation correction unit 316 reads out from the memory 310 a gradation correction table (γLUT) corresponding to an attribute or a screen, and converts image data based on the γLUT. LUT_SC1 is a gradation correction table corresponding to an image screen. LUT_SC2 is a gradation correction table corresponding to a text screen. LUT_SC3 is a gradation correction table corresponding to a COPY screen. The gradation correction table LUT_SC4 is a gradation correction table corresponding to an error diffusion method. LUT_SC1, LUT_SC2, LUT_SC3 and LUT_SC4 correspond to the conversion conditions for converting image data. The γLUT generation unit 307 updates these γLUTs by executing calibration.

The gradation correction unit 316 may be realized by an integrated circuit such as an ASIC, or may be realized by a CPU 300 executing a program. ASIC is an abbreviation for Application Specific Integrated Circuit. The gradation correction unit 316 may convert the image data based on a gradation correction table, or may convert the image data based on a conversion formula.

The halftone processing unit 317 performs halftoning on image data converted by the gradation correction unit 316, the halftoning being suitable for a type (attribute) of the image. The halftone processing unit 317, based on an image screen, converts image data relating to an image and image data relating to graphics so that a photograph or a graphic becomes an image having excellent gradation property. The halftone processing unit 317, based on a text screen, converts the image data relating to the text so that characters are clearly printed. When the operator selects the error diffusion method, the halftone processing unit 317 converts the image data based on the error diffusion method. Here, for example, when moire occurs in a high-resolution image, the operator selects the error diffusion method to suppress moire. The halftone processing unit 317 converts the image data of the original read by the reader 400 based on the COPY screen.

The image data to which screening was applied by the halftone processing unit 317 is output to the printer 101. For example, the halftone processing unit 317 outputs yellow image data to the station 120. The printer 101 forms an image on the sheet P based on the image data input from the halftone processing unit 317.

A pattern generator 305 outputs image data of a measurement image used in calibration and correction value determination processing. The halftone processing unit 317 performs halftoning on the image data output from the pattern generator 305. An image screen is applied to image data for updating LUT_SC1, which is a gradation correction table corresponding to an image screen. A text screen is applied to image data for updating LUT_SC2, which is a gradation correction table corresponding to a text screen. A COPY screen is applied to image data for updating LUT_SC3, which is a gradation correction table corresponding to a COPY screen. An error diffusion is applied to image data for updating LUT_SC4, which is a gradation correction table corresponding to error diffusion. The image data subjected to the halftoning is transferred to the printer 101. The printer 101 forms an image for measurement on the sheet P based on the image data transferred from the halftone processing unit 317. The CPU 300 conveys the sheet P on which the measurement image is formed toward the spectral sensor 200, and causes the spectral sensor 200 to measure the measurement image on the sheet P. The spectral sensor 200 calculates the spectral reflectance of the measurement image 220 by the calculation unit 204, and outputs it to a density conversion unit 306.

The density conversion unit 306 converts the measurement results of the YMC measurement images into density values using a status A filter. The density conversion unit 306 converts the measurement results of a K (black) measurement image into density values using a visual filter. The status A filter and the visual filter are calculation methods defined by ISO-5/3. A printer controller 301 controls image forming conditions and generates a gradation correction table based on the measurement result (density value) converted by the density conversion unit 306. The printer controller 301 includes, for example, an LPW adjustment unit 308 for adjusting the intensity of the laser of the exposure apparatus 103, and a γLUT generation unit 307 for generating a gradation correction table. That is, the LPW adjustment unit 308 and the γLUT generation unit 307 are execution units that execute calibration. The LPW adjustment unit 308 determines the intensity of the laser so that the maximum value of the density of the measurement image becomes the target maximum density. The γLUT generation unit 307 generates a gradation correction table (γLUT) so that the gradation characteristic of the measurement image becomes an ideal gradation characteristic. The measurement image is formed for each color and for each screen.

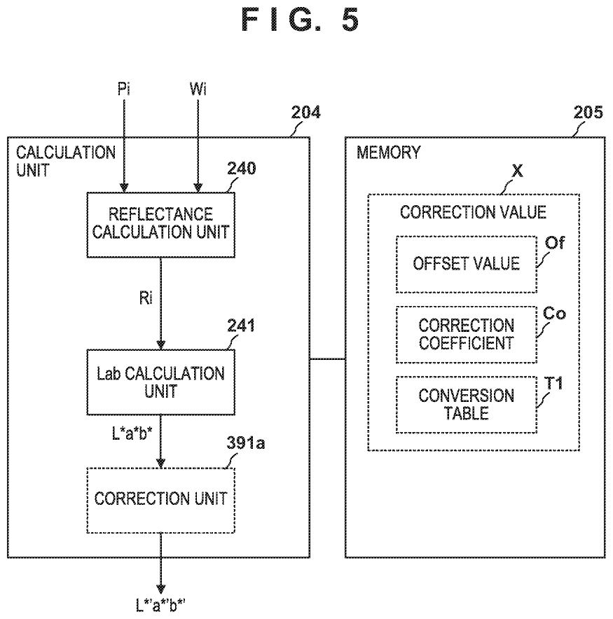

As illustrated in FIG. 4, a correction unit 391a outputs the corrected L*′a*′b*′ to the density conversion unit 306. In FIG. 4, the determination unit 390 and the correction unit 391a are separated from the CPU 300, but the determination unit 390 and the correction unit 391a may be realized by the CPU 300. As illustrated in FIG. 5, the correction unit 391a may be provided inside the calculation unit 204. The calculation unit 204 may be realized by a CPU and a control program, or may be realized by hardware such as an ASIC.

The CPU 300 drives the motor M1 to reciprocate the spectral sensor 200e in the main scanning direction. For example, the motor M1 is connected to the spectral sensor 200e via a gear mechanism, a wire, or the like, and moves the spectral sensor 200e. Thus, the spectral sensor 200e is operable in the main scanning direction, in contrast to the fixed spectral sensors 200a to 200d.

Arrangement of Spectral Sensors

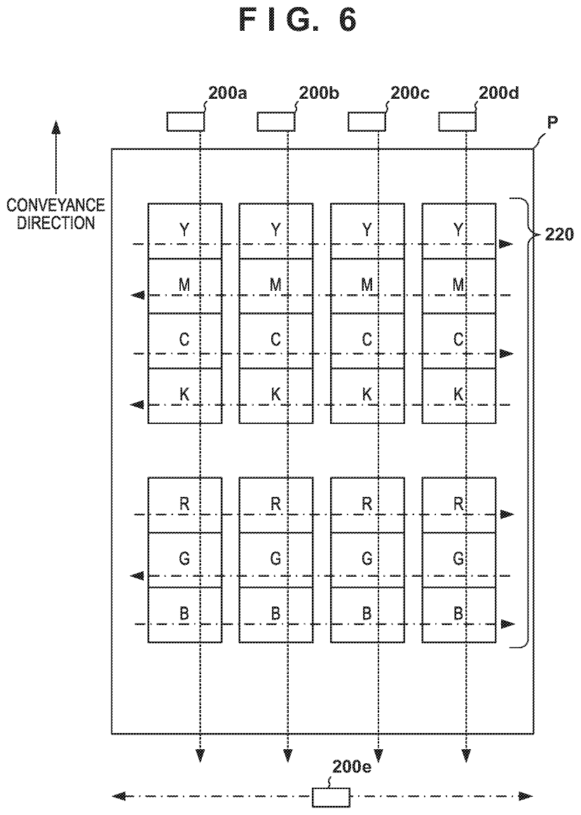

As illustrated in FIG. 6, the spectral sensors 200a to 200d may be arranged along a direction orthogonal to the conveyance direction (main scanning direction). The measurement image 220 has a plurality of test patterns arranged corresponding to the spectral sensors 200a to 200d. When the sheet P is conveyed in the conveyance direction (sub-scanning direction), the spectral sensors 200a to 200d sequentially measure YMCKRGB test patterns.

The spectral sensor 200e measures the measurement image 220 by reciprocating in the main scanning direction. For example, by moving from left to right in FIG. 6, the spectral sensor 200e measures four test patterns of the Y color in order. Next, by moving from right to left in FIG. 6, the spectral sensor 200e measures four test patterns of the M color in order. The test patterns of the respective colors of the CKRGB are measured in the same manner. Note that the spectral sensor 200e may read four test patterns while always moving from left to right.

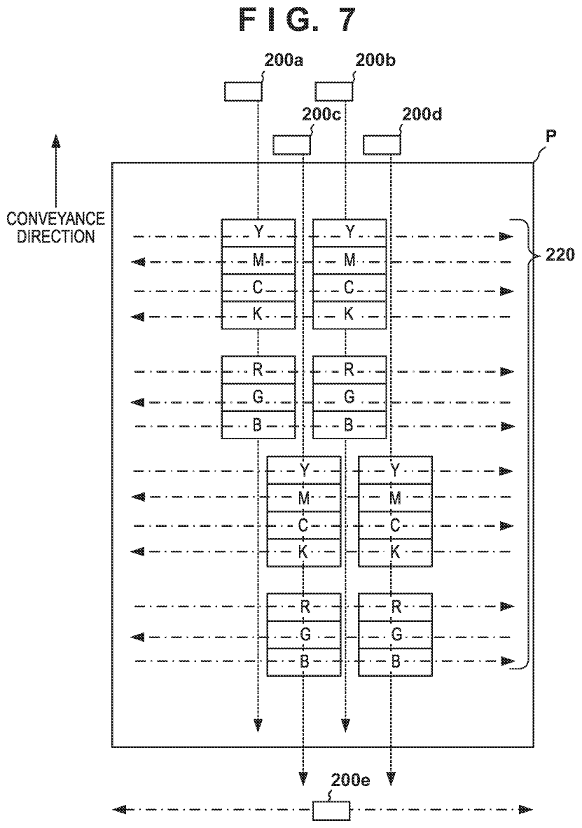

As illustrated in FIG. 7, the spectral sensors 200a and 200b and the spectral sensors 200c and 200d may be arranged at positions shifted in the conveyance direction. The arrangement of the YMCKRGB test patterns in the measurement image 220 is also changed in accordance with the arrangement of the spectral sensors 200a and 200b and the spectral sensors 200c and 200d. Such an arrangement is effective for small-sized paper having a narrow sheet width in the main scanning direction.

Incidentally, according to FIG. 1, the spectral sensor 200e is arranged on the downstream side of the spectral sensors 200a to 200d in the conveyance direction of the sheet P. However, the spectral sensor 200e may be arranged on the upstream side of the spectral sensors 200a to 200d in the conveyance direction of the sheet P. However, when the spectral sensor 200e reads the measurement image, it is necessary to stop the sheet P and read the test pattern of each color, and therefore it is convenient to arrange the spectral sensor 200e in the buffer 141.

Flowchart

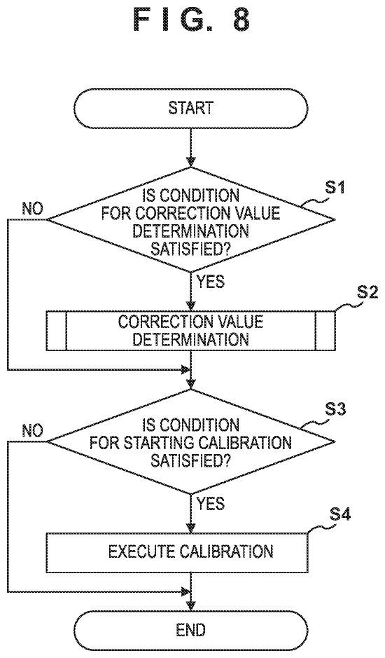

FIG. 8 is a main flowchart for describing calibration for correcting image forming conditions. The calibration includes a determination process for determining a correction value X.

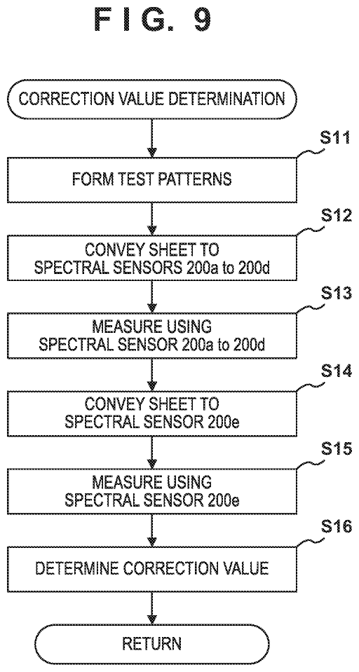

In step 51, the CPU 300 determines whether a correction value determination condition is satisfied. The determination condition is a condition for executing a process for determining the correction value. The condition may be, for example, that the user has instructed execution through the operation unit 180, that the image forming apparatus 100 has been activated, or that an environmental condition variation process has exceeded a predetermined value. The environmental condition is a temperature, a humidity, or the like detected by an environmental sensor connected to the CPU 300. In particular, the process of determining the correction value is performed prior to it becoming impossible to accurately correct the respective measured results of the spectral sensors 200a to 200d by the correction value X which is being held in the RAM 309. When the determination condition is satisfied, the CPU 300 advances the process to step S2. When the determination condition is not satisfied, the CPU 300 advances the process to step S3. In step S2, the CPU 300 executes a process for determining the correction value. Details of the determination process will be described later with reference to FIG. 9.

In step S3, the CPU 300 determines whether a condition for starting calibration is satisfied. The start condition may be, for example, that the user has instructed execution through the operation unit 180, that the image forming apparatus 100 has been activated, or that an environmental condition variation process has exceeded a predetermined value. The fact that the number of images to be formed exceeds a threshold may be adopted as the start condition. When the start condition is satisfied, the CPU 300 advances the process to step S4. If the start condition is not satisfied, the CPU 300 ends the calibration illustrated in FIG. 8.

In step S4, the CPU 300 executes calibration of image forming conditions. The calibration includes maximum density adjustment processing and gradation correction condition adjustment processing. The maximum density adjustment processing includes adjusting the charging potential, the intensity of the laser of the exposure apparatus 103 (exposure intensity), and the development bias. The adjustment process of the gradation correction condition includes a process of updating the γLUT. In both cases, the CPU 300 causes the pattern generator 305 to output the image data of the measurement image, and causes the printer 101 to form the measurement image on the sheet P. In addition, the CPU 300 causes the spectral sensors 200a to 200d to measure the measurement images, adjusts the charging potential, the exposure intensity, and the development biases based on the measurement results, and corrects the gradation correction condition. In any case, the CPU 300 corrects the measurement results of the spectral sensors 200a to 200d using the correction value X determined in step S2, and modifies the image forming conditions using the corrected measurement results. This also improves the accuracy of the calibration.

Details of Correction Value Determination Process

FIG. 9 is a flowchart for describing a process for determining a correction value. In step S11, the CPU 300 (determination unit 390) uses the pattern generator 305 and the printer 101 to form a measurement image including test patterns for the determination process on the sheet P. The pattern generator 305 outputs image data designated by the determination unit 390. For example, YMCKRGB test patterns illustrated in FIG. 6 and FIG. 7 are produced at 100% density. In step S12, the CPU 300 (determination unit 390) controls the conveyance rollers and the flapper 132 to convey the sheet P to the spectral sensors 200a to 200d.

In step S13, the CPU 300 (determination unit 390) measures the measurement image formed on the sheet P using the spectral sensors 200a to 200d. Here, a measurement result (L*a*b*) is acquired for each of the spectral sensors 200a to 200d. The measurement result of the Y color of the spectral sensor 200a may be referred to as L*a*b*-Ya. Similarly, the measurement result of the M color of the spectral sensor 200b may be referred to as L*a*b*-Mb. In this manner, a combination of lowercase alphabet for distinguishing the spectral sensors 200a to 200d and uppercase alphabet for indicating color may be used to identify the measurement results.

In step S14, the CPU 300 (determination unit 390) controls the conveyance rollers and the flappers 133 and 134 to convey the sheet P to the spectral sensor 200e. In step S15, the CPU 300 (determination unit 390) measures the measurement image formed on the sheet P using the spectral sensor 200e. The determination unit 390 drives the motor M1 to cause the spectral sensor 200e to measure the YMCKRGB test patterns while reciprocating the spectral sensor 200e. The determination unit 390 stops the conveyance roller upon reading of the test pattern of each color. This is because the reciprocating motion of the spectral sensor 200e requires a considerable amount of time. When the spectral sensors 200a to 200d measure the measurement images, the conveyance roller does not have to be stopped. This is because the spectral sensors 200a to 200d are fixed and do not reciprocate. Here, the measurement results (L*a*b*-Yae, L*a*b*-Ybe, . . . , L*a*b*-Bde) of the spectral sensor 200e are obtained. Here, L*a*b*-Yae represents the measurement result for the Y color measured by the spectral sensor 200e corresponding to the measurement result L*a*b*-Ya for the Y color measured by the spectral sensor 200a. In other words, L*a*b*-Ya and L*a*b*-Yae indicate the measurement results for the leftmost test pattern of the four Y color test patterns illustrated in FIG. 6. Similarly, L*a*b*-Ybe represents the measurement result for the Y color measured by the spectral sensor 200e corresponding to the measurement result L*a*b*-Yb for the Y color measured by the spectral sensor 200b. In other words, L*a*b*-Yb and L*a*b*-Ybe indicate the measurement results for the second leftmost test pattern of the four Y color test patterns illustrated in FIG. 6. Since all of L*a*b*-Ya to L*a*b*-Ba are the results of the spectral sensor 200a, they may be collectively referred to as L*a*b*-a. In this manner, the spectral sensors 200a to 200d and the spectral sensor 200e measure test patterns respectively formed at the same positions.

In step S16, a CPU 300 (a determination unit 390) may determine correction values Xa, Xb, Xc, and Xd for correcting the measurement results of the spectral sensors 200a to 200d using the measurement results of the spectral sensors 200a to 200d and the measurement results of the spectral sensor 200e. The correction values Xa, Xb, Xc, and Xd can be determined for each of L*, a*, and b*.

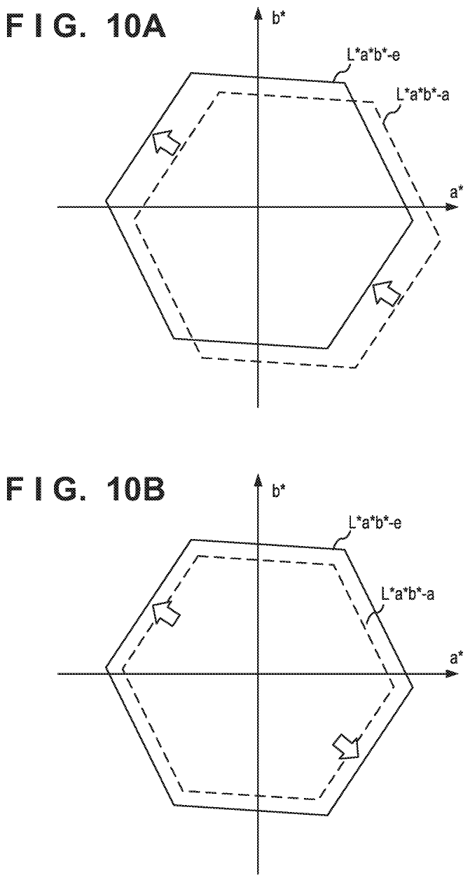

FIG. 10A illustrates the measurement result L*a*b*-a of the spectral sensor 200a and the measurement result L*a*b*-e of the spectral sensor 200e in the a*-b* plane. The a*-b* plane is used for simplicity of explanation. As illustrated in FIGS. 10A and 10B, it can be seen that there are individual differences between the spectral sensor 200a and the spectral sensor 200e. Therefore, the determination unit 390 determines the offset value Ofa for matching the measurement result L*a*b*-a of the spectral sensor 200a with the measurement result L*a*b*-e of the spectral sensor 200e. Although not illustrated here, similar individual differences exist in the spectral sensors 200b to 200d. Therefore, the determination unit 390 determines offset values Ofb, Ofc, and Ofd for matching the measurement results L*a*b*-b, L*a*b*-c, and L*a*b*-d of the spectral sensors 200b to 200d with the measurement result L*a*b*-e. The offset value is obtained for each of L*, a*, and b*. The determination unit 390 writes the offset value Of into the RAM 309.

Correction of the measurement result with the offset value Of thus obtained improves the measurement accuracy of L*a*b*. For example, when the test pattern of Y [100%] was tested, ΔE when the measurement results of the spectral sensors 200a to 200d were not corrected was 2.2. On the other hand, by correcting the measurement results, ΔE became 1.2, and a significant improvement was observed.

In the first embodiment, the configuration of the spectral sensor 200e is the same as the configuration of the spectral sensors 200a to 200d. If a sensor having higher performance than the spectral sensors 200a to 200d is employed as the spectral sensor 200e, the correction accuracy will be further improved.

### Second Embodiment

As illustrated in FIG. 2, the spectral sensors 200a to 200e have a white LED 201. Since there are individual differences in the white LED 201, these individual differences may lead to errors in the measured results. The light emission amount of the white LED 201 of the spectral sensors 200a to 200e is adjusted to a predetermined light emission amount by using a result of measuring the white reference plate 250 by the line sensor 203. However, there are also individual differences in the white reference plate 250.

FIG. 10B illustrates differences in the measurement results caused by differences in the light emission amount. In this example, it is understood that the light emission amount of the spectral sensor 200a is smaller than the light emission amount of the spectral sensor 200e. That is, in the method of the first embodiment, the measurement results are offset in the a*-b* plane, but the measurement results of the spectral sensors 200a to 200d do not coincide with the spectral sensor 200e by that alone. That is, a multiplication-type correction coefficient for correcting the difference in the light emission amount may be necessary.

Therefore, the measurement image 220 may include test patterns for correcting a difference in the light emission amount. The CPU 300 executes steps S11 to S16. That is, the determination unit 390 causes the spectral sensors 200a to 200e to measure the test patterns for correcting the difference in the light emission amount, and determines the correction value X (a correction coefficient Co) for reducing the error of the measurement result L*a*b based on the difference in the light emission amount. This test patterns are test patterns of a size that is commonly read by the spectral sensors 200a to 200e. The determination unit 390 determines the correction coefficient Co so that the measurement results L*a*b* of the spectral sensors 200a to 200e coincide with each other, and stores the correction coefficient Co in the RAM 309. For example, the determination unit 390 may determine the correction coefficient Co such that the measurement result L*a*b* of the spectral sensor 200e matches the measurement results L*a*b* of the spectral sensors 200a to 200e, and may store the correction coefficient Co in the RAM 309. As described above, the spectral sensor 200e may be employed as a reference sensor, but any one of the spectral sensors 200a to 200d may be employed as the reference sensor. The correction coefficient Co is a multiplication coefficient. It has been found that ΔE for the spectral sensors 200a to 200d is reduced to 1.0 by employing the correction coefficient Co in addition to the correction value X.

### Third Embodiment

In the first embodiment, an offset value Of which is added to or subtracted from the measurement result is proposed. In the second embodiment, a correction coefficient Co which is multiplied by the measurement result is further proposed. Since these are correction values basically determined by the test pattern of 100% density, there is a possibility that a correction residual is generated for other densities. In the third embodiment, a conversion table T1 for converting an actual measurement result into a corrected measurement result is proposed as the correction value X.

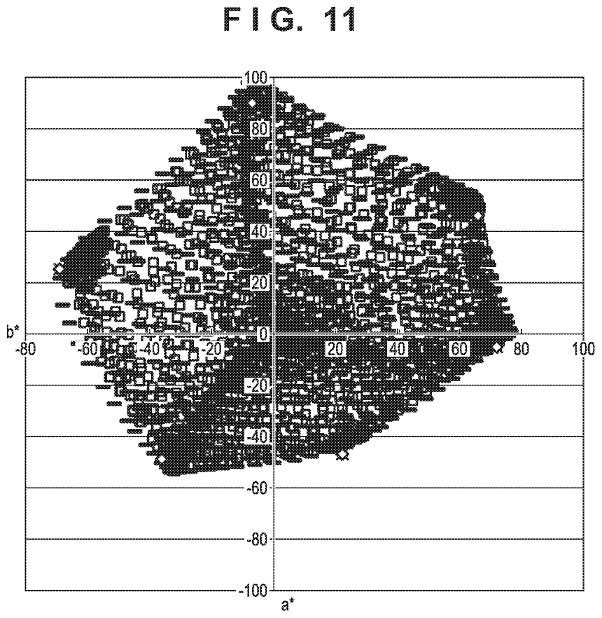

The CPU 300 executes steps S11 to S16. In particular, the determination unit 390 forms the measurement image 220 including a large number of test patterns (e.g.: 1028 test patterns) on the sheet P in step S11. For example, as FIG. 11 illustrates, a number of test patterns are generated to correspond to various coordinates in the a*-b* plane. In steps S12 to S15, test patterns are measured by the spectral sensors 200a to 200e.

In step S16, the determination unit 390 determines one correction coefficient for each test pattern. For example, it is assumed that the first test pattern was a pattern formed by mixing colors of Y:10%, M:10%, and C:10%. The spectral sensor 200a and the spectral sensor 200e each measure a first test pattern. The determination unit 390 obtains a difference between the measurement result of the spectral sensor 200a and the measurement result of the spectral sensor 200e as a correction coefficient. This correction coefficient is determined for each of L*, a*, and b*. For example, the correction coefficient of L* is calculated as +0.01, the correction coefficient of a* is calculated as +0.02, and the correction coefficient of b* is calculated as −0.01. The determination unit 390 performs this operation on a plurality of test patterns having different YMCK density combinations. Finally, the conversion table T1 for converting the measurement result L*b*a* into the measurement result L*′b*′a*′ for each of the spectral sensors 200a to 200d is completed and stored in the RAM 309.

In the first embodiment, generally test patterns having a density of 100% are used, but in the present embodiment, since test patterns having various densities are used, a conversion table T1 capable of correcting measurement results with high accuracy at various densities is created. The correction unit 391a converts the actual measurement result L*b*a* into the measurement result L*′b*′a*′ using the conversion table T1. This improved the ΔE for the spectral sensors 200a to 200d to 0.8.

### Fourth Embodiment

In the first to third embodiments, the measurement result L*a*b* is directly corrected by the correction value X. However, any parameter from the output value of the line sensor 203 to the measurement result L*a*b* may be corrected. Therefore, as an example, a method of correcting the measurement result L*a*b* by correcting the spectral reflectance Ri is proposed.

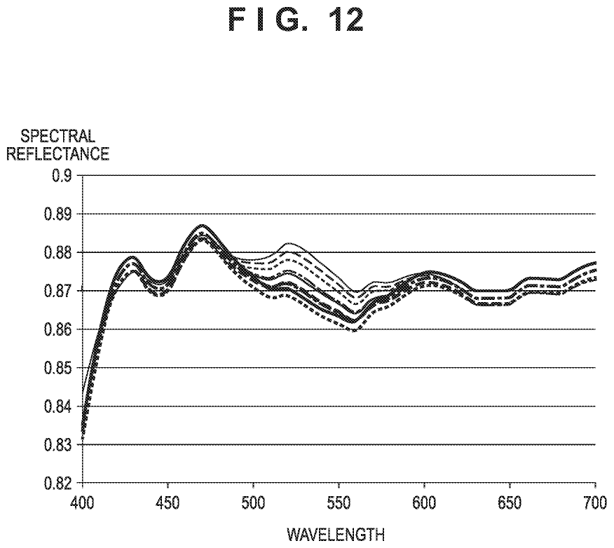

FIG. 12 is a diagram illustrating spectral characteristics of nine spectral sensors. The horizontal axis represents wavelength. The vertical axis represents the spectral reflectance. Especially, in spectral sensors employing an inexpensive light emitting element, individual differences in spectral reflectance become large. As illustrated in FIG. 12, since the spectral reflectance differs for each wavelength, a correction value X for the spectral reflectance for each wavelength is necessary. However, the work to determine the correction value X over the entire range of wavelengths takes a long time, and the storage capacity of the RAM 309 must be increased. Therefore, the determination unit 390 creates a correction table T2 for correcting the actual spectral reflectance Ri to the corrected spectral reflectance Ri′ for a wavelength range in which the spectral reflectance varies widely. In the case illustrated in FIG. 12, a wavelength range of at least 500 nm to 550 nm may be sufficient, but here, a correction table T2 may be created for every 10 nm in the range of 400 nm to 700 nm.

The CPU 300 executes steps S11 to S16. In steps S11 to S15, the determination unit 390 causes the spectral sensors 200a to 200d and the spectral sensor 200e to measure the measurement image 220 as described above. Here, the spectral reflectance Ri is obtained as a measurement result. In step S16, the determination unit 390 determines the correction value of the spectral reflectance so that the spectral reflectance Ri of each of the spectral sensors 200a to 200d matches the spectral reflectance Ri of the spectral sensor 200e. A collection of correction values obtained for each wavelength is a correction table T2. The determination unit 390 stores the correction table T2 as the correction value X in the memory 205.

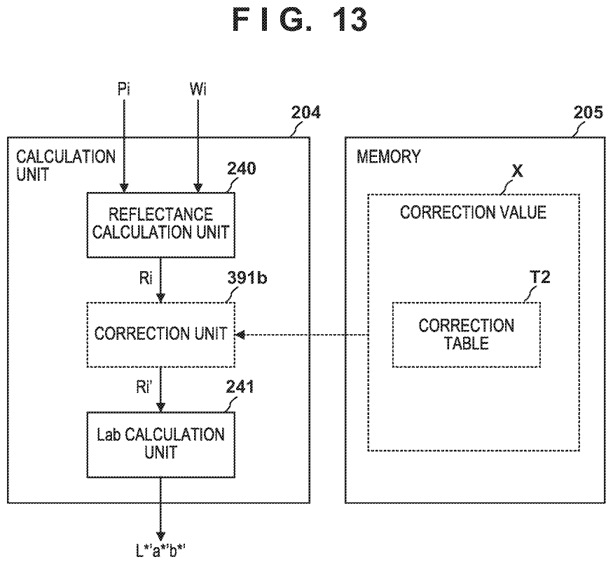

As illustrated in FIG. 13, a correction unit 391b references the correction table T2 held in the memory 205 and acquires a correction value Xi for each pixel (each wavelength) in the line sensor 203. Further, the correction unit 391b multiplies the spectral reflectance Ri output from the reflectance calculation unit 240 by the correction value Xi to obtain the corrected spectral reflectance Ri′, and outputs the obtained spectral reflectance Ri′ to the Lab calculation unit 241. As a result, the measurement result output from the Lab calculation unit 241 becomes L*′a*′b*′. Note that it has been found that ΔE for the spectral sensors 200a to 200d is reduced to 0.4 by applying the fourth embodiment. When the correction unit 391b is provided, the correction unit 391a may be omitted. Both the correction unit 391a and the correction unit 391b may be provided.

### Summary

As illustrated in FIG. 1, the conveyance paths 135 and 139 function as a conveyance unit that conveys the sheet P in a first direction. The stations 120 to 123 function as an image forming unit for forming an image on the sheet P. The spectral sensors 200a to 200d function as a plurality of first spectral sensors for measuring a first measurement image formed on the sheet P by the image forming unit. As illustrated in FIG. 6 and the like, the first measurement image (e.g.: a yellow test pattern) is formed along a second direction (e.g.: a main scanning direction) intersecting the first direction. The spectral sensor 200e functions as a second spectral sensor for measuring the first measurement image formed on the sheet P. The motor M1 functions as a movement unit that moves the second spectral sensor along a third direction intersecting the first direction. The third direction may be a direction parallel to the main scanning direction. When the conveying speed of the sheet P is low, the third direction may be inclined with respect to the main scanning direction. Basically, the third direction and the conveyance direction of the sheet P are orthogonal to each other. The determination unit 390 functions as a determination unit that determines a correction value for correcting an output value of each of the plurality of first spectral sensors. The determination unit 390 determines the correction value based on a measurement result of the first measurement image acquired by the plurality of first spectral sensors and a measurement result of the first measurement image acquired by the second spectral sensor while the second spectral sensor is being moved in the third direction by the movement unit. The correction units 391a and 391b correct an output value output from each of the plurality of first spectral sensors with the correction value determined by the determination unit by measuring a second measurement image that is formed by the image forming unit and that is for modifying an image forming condition of the image forming unit. The correction units 391a and 391b may be collectively referred to as the correction unit 391. The second measurement image for modifying the image forming condition is a measurement image for calibration, and may be fundamentally different from the measurement image 220 for correcting the measurement result. The LUT generation unit 307 and the LPW adjustment unit 308 function as a modification unit that modifies the image forming condition based on the output value corrected by the correction unit. As described above, according to the present embodiment, individual differences between a plurality of spectral sensors are accurately corrected.

The plurality of first spectral sensors may all be spectral sensors of the same specification. The white LED 201 is an exemplary light emitting element that outputs light onto the sheet P. The line sensor 203 is an example of a light receiving element that receives reflected light from the sheet P or an image formed on the sheet P. The reflectance calculation unit 240 is an example of a first calculation unit that calculates the spectral reflectance based on the light reception result of the light receiving element. The Lab calculation unit 241 is an example of a second calculation unit that calculates chromaticity, which is an output value, based on the spectral reflectance. The correction unit 391 may correct the output value by correcting the spectral reflectance or chromaticity using the correction value.

Each of the plurality of first spectral sensors may include a light emitting element, a light receiving element, a first calculation unit, a second calculation unit, and the like. Further, the second spectral sensor may have a light emitting element, a light receiving element, and the like similarly to the first spectral sensor. That is, the first spectral sensor and the second spectral sensor may be of the same model (the same product or the same specification). The first spectral sensor and the second spectral sensor may be different products (of different specifications). For example, the measurement accuracy of the second spectral sensor may be higher than the measurement accuracy of the first spectral sensor. In this case, the correction accuracy will be further improved.

As described in the first embodiment, the correction value may be an offset value Of to be added to the chromaticity. The correction value may be a coefficient to be multiplied with the chromaticity (e.g.: the correction coefficient Co). The output value may be L*a*b* data in the L*a*b* color space. The determination unit 390 may create a conversion table (e.g.: the correction table T2 or the conversion table T1) for converting the output value into the output value corrected by the correction value. The correction unit 391 may convert the output value into a corrected output value using a conversion table.

As illustrated in FIG. 2, the light receiving element may have n pixels arranged or configured to receive light of different wavelengths. The correction unit 391 may correct the output values of m pixels (n>=m) that receive light of a predetermined range of wavelengths among the n pixels. For example, the n pixels may be arranged to receive light at wavelengths ranging from 380 nanometers to 720 nanometers. The m pixels may be arranged to receive light at wavelengths ranging from 400 nanometers to 700 nanometers. As described with reference to FIG. 12, the m pixels may be determined so as to correspond to a wavelength range having a large variation in spectral reflectance in the plurality of spectral sensors 200a to 200d. For example, the m pixels may be arranged to receive light at wavelengths ranging from 500 nanometers to 550 nanometers.

As illustrated in FIG. 7, at least two spectral sensors of the plurality of first spectral sensors may be arranged along the second direction. This reduces the number of times the second spectral sensor reciprocates along the second direction. As illustrated in FIGS. 6 and 7, the second direction may be orthogonal to the first direction. However, the angle at which the second direction and the first direction intersect may be slightly deviated from 90°. As illustrated in FIGS. 6 and 7, the third direction (moving direction of the spectral sensor 200e) may be parallel to the second direction (main scanning direction). The motor Ml may reciprocate the second spectral sensor along the third direction. The second spectral sensor may measure the first measurement image in each of a forward path and a return path in the reciprocating motion. This makes it possible to efficiently read the test pattern constituting the measurement image 220.

### Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-048744, filed Mar. 15, 2019 which is hereby incorporated by reference herein in its entirety.

What is claimed is:

1. An image forming apparatus comprising:
a conveyance unit configured to convey a sheet in a first direction;
an image forming unit configured to form an image on the sheet;
a plurality of first spectral sensors configured to measure a first measurement image formed by the image forming unit on the sheet along a second direction intersecting the first direction;
a second spectral sensor configured to measure the first measurement image formed on the sheet;
a movement unit configured to move the second spectral sensor along a third direction intersecting the first direction; and
a controller configured to
determine a correction value for correcting an output value of each of the plurality of first spectral sensors, based on a measurement result of the first measurement image acquired by the plurality of first spectral sensors and a measurement result of the first measurement image acquired by the second spectral sensor while the second spectral sensor is being moved in the third direction by the movement unit,
correct, using the determined correction value, the output value output from each of the plurality of first spectral sensors by measuring a second measurement image that is formed by the image forming unit and that is for modifying an image forming condition of the image forming unit, and modify the image forming condition based on the output value corrected by the correction unit.

2. The image forming apparatus according to claim 1, wherein
the plurality of first spectral sensors are all spectral sensors of the same specification, and
each of the plurality of first spectral sensors further comprises
a light emitting element configured to output light onto the sheet, and
a light receiving element configured to receive reflected light from the sheet or an image formed on the sheet, and
the controller is further configured to
calculate a spectral reflectance based on a light reception result of the light receiving element,
calculate a chromaticity, which is the output value, based on the spectral reflectance, and
correct the output value by correcting the spectral reflectance or the chromaticity using the correction value.

3. The image forming apparatus according to claim 1, wherein
the plurality of first spectral sensors and the second spectral sensor are all spectral sensors of the same specification, and
the plurality of first spectral sensors and the second spectral sensor each further comprises
a light emitting element configured to output light onto the sheet, and
a light receiving element configured to receive reflected light from the sheet or an image formed on the sheet, and
the controller is further configured to
calculate a spectral reflectance based on a light reception result of the light receiving element,
calculate a chromaticity based on the spectral reflectance, and
correct the output value by correcting the spectral reflectance or the chromaticity of each of the plurality of first spectral sensors using the correction value.

4. The image forming apparatus according to claim 2, wherein
the correction value is an offset value added to the chromaticity.

5. The image forming apparatus according to claim 2, wherein
the correction value is a coefficient multiplied with the chromaticity.

6. The image forming apparatus according to claim 1, wherein
the output value is L*a*b* data in an L*a*b* color space, and
the controller is further configured to
generate a conversion table for converting the output value into an output value corrected by the correction value and
convert the output value into the corrected output value using the conversion table.

7. The image forming apparatus according to claim 2, wherein
the light receiving element has n pixels arranged or configured to receive light of different wavelengths, and
the controller is further configured to correct an output value for, from among the n pixels, m pixels (n>=m) that receive light of wavelengths in a predetermined range.

8. The image forming apparatus according to claim 7, wherein
the n pixels are arranged so as to receive light at wavelengths ranging from 380 nanometers to 720 nanometers, and
the m pixels are arranged so as to receive light at wavelengths in a range from 400 nanometers to 700 nanometers.

9. The image forming apparatus according to claim 7, wherein
the n pixels are arranged to receive light at wavelengths in a range from 380 nanometers to 720 nanometers, and
the m pixels are arranged to receive light at wavelengths in a range from 500 nanometers to 550 nanometers.

10. The image forming apparatus according to claim 1, wherein
at least two spectral sensors of the plurality of first spectral sensors are arranged along the second direction.

11. The image forming apparatus according to claim 1, wherein
the second direction is orthogonal to the first direction.

12. The image forming apparatus according to claim 1, wherein
the third direction is parallel to the second direction.

13. The image forming apparatus according to claim 1, wherein
the movement unit is further configured to reciprocate the second spectral sensor along the third direction, and
the second spectral sensor is further configured to measure the first measurement image in a forward path and a return path in the reciprocating motion.
